(19) United States
(12) Patent Application Publication
(10) Pub. No.: US 2014/0258313 A1
(43) Pub. Date: Sep. 11, 2014

(54) Musiqo quality score

(71) Applicant: Matthew McCallum, Farnham (GB)

(72) Inventor: Matthew McCallum, Farnham (GB)

(21) Appl. No.: 13/815,519

(22) Filed: Mar. 11, 2013

(51) Int. Cl. G06F 17/30

(52) U.S. Cl. CPC G06F 17/30743
USPC 707/751

(57) ABSTRACT

A method for applying a quality score to digital content automatically, based on how people naturally use and interact with it.

Using an adjustable algorithm, the method tracks interactions, and automatically applies a score based on those interactions. The score is calculated and continuously adjusted based on the interactions of all people who use interact with the digital content.

### BACKGROUND

When choosing digital content such as music, many people are interested in and influenced by other people's tastes.

Measuring and recording ‘taste’ is currently primarily achieved using 2 different measures: popularity and rating:
i. Popularity is usually based purely on unit volume—how many times an item acquired or used. This is often calculated by comparing the volume of acquisitions (or ‘listens’ in the case of music) of all content in the vendor's library, and expressing the popularity as a percentage or a graphic ‘bar’.
ii. Ratings are different in that they are explicitly submitted by people who have acquired the item, usually represented as a ‘5 star’ mechanism. The person chooses their ‘star rating’, and the system then displays the average in order to influence other would-be consumers of the content.

These are tried and tested methods, but they are flawed:

Relying on popularity alone does not describe the quality of ‘niche’ items. There here are often content items which are very obscure (and therefore not popular). However this does not mean that they are poor quality.

For example, a person might be looking for ‘Japanese Jazz’ music content. Using current streaming services or digital music stores, if they were to sort by popularity, Japanese Jazz would rank low—because it is not popular relative to other types of music.

Relying on people to provide a rating can provide a reliable measure of quality. However, the downside is that it puts an onus on people to actively enter (or choose) the rating. Many people simply don't do this. It is also open to generating false information—for example a person could simply enter a high rating for a piece of music which they actually strongly dislike. This has a direct effect on the overall score making it inaccurate.

In contrast, the Musiqo Quality Score is different to these methods:

The Musiqo Quality Score applies a quality score to the content automatically, based purely on how people naturally use and interact with it. It doesn't simply measure volume of acquisitions, and it doesn't require that people actively select a rating.

Using an adjustable algorithm, it tracks positive interactions, and automatically applies a score based on those interactions. The score is calculated and continuously adjusted based on the interactions of all people who use interact with it.

The benefit that the Musiqo Quality Score brings is that presents people with a view of a piece of the content's true quality, not just its popularity. This is important to people who are fans of niche styles (which aren't popular, like the ‘Japanese Jazz’ music example shown above). What's more, it does this naturally and automatically without people having to actively contribute.

### DETAILED DESCRIPTION

How the Musiqo Quality Score Works

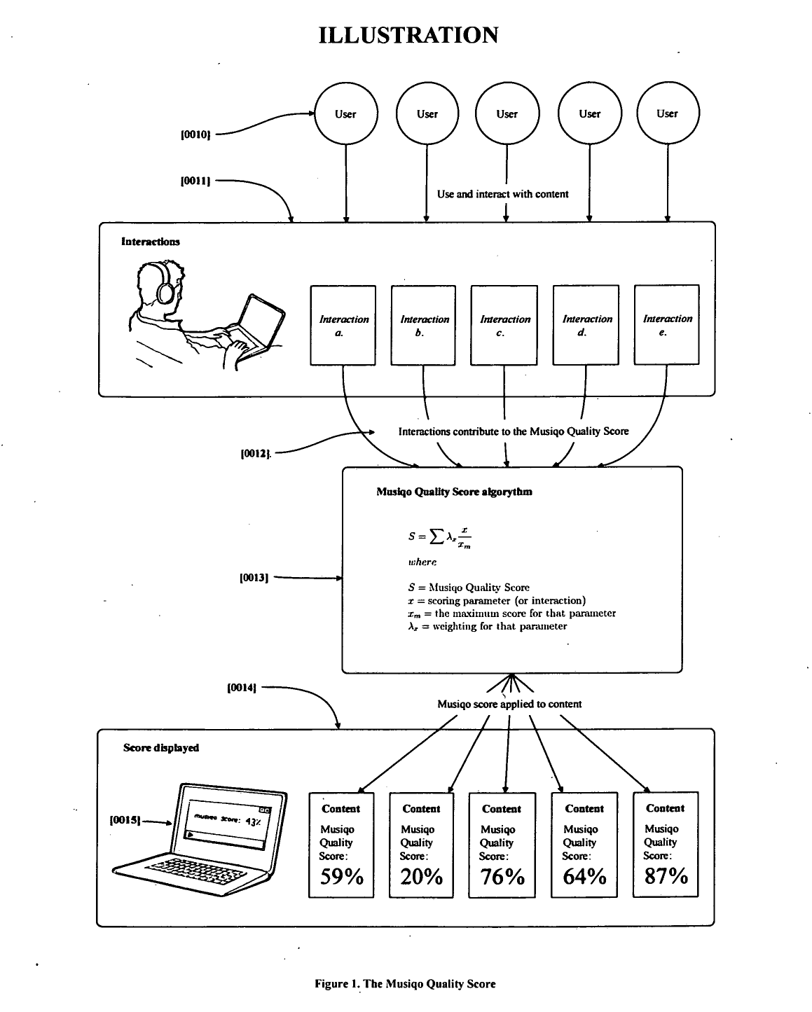

FIG. 1 illustrates how the Musiqo Quality Score is automatically applied to digital content:

Users search or browse the Digital Content Provider's system for digital content, using a digital device. For example this could include (but is not limited to) these devices:
i. Personal computer
ii. Laptop or mobile computer
iii. Smart phone
iv. Tablet device
v. E-book reader
vi. Television

They then use and interact with the content on the Digital Content Provider's system. For example, if the content is music, the interactions could be:
Interaction a. Acquire (obtain the song, if it is free)
Interaction b. Buy (purchase the song, if it is not free)
Interaction c. Play (Play the song audio)
Interaction d. Add to playlist (add the song to a play list that they have created, so that they can listen to it again)
Interaction e. Like (click ‘Like’ against a song)

These positive actions are tracked by the Digital Content Provider's system so that the algorithm can update the Musiqo Quality Score.

The Musiqo Quality Score algorithm continuously updates the Musiqo Quality Score (by updating the content data hosted with the Digital Content Provider's system), based on the interactions (see Algorithm).

The score is displayed against the content items as a percentage when displayed by the Digital Content Provider.

Other people can now reference the Musiqo Quality Score and use it to gauge the quality of the content that they are searching or browsing.

Algorithm

The Musiqo Quality Score algorithm can be expressed as a formula:

$$S = \sum {λ}_{x} \frac{x}{{x}_{m}}$$

where
S=Musiqo Quality Score
χ=scoring parameter (or interaction)
χₘ=the maximum score for that parameter
λ_{χ}=weighting for that parameter

This can also be described as:
interaction a for an item÷interaction max across all Items×interaction weighting+interaction b for an item÷interaction max across all Items×interaction weighting+interaction c for an item÷interaction max across all Items×interaction weighting+etc.

Configurable Variables

The key rule which drives the Musiqo Quality Score is that natural, positive interactions automatically affect it. In the examples shown above (and in FIG. 1), these interactions could be ‘acquire’, ‘buy’, ‘play’, ‘add to playlist’ or ‘like’.

However the Musiqo Quality Score mechanism is configurable, and is not limited to these specific interactions.

The interactions can be changed, removed, swapped out, or new ones added in order to fine tune the scoring mechanism—especially if new interactions arise.

In addition to the interaction items being variable, each interaction's weighting can also be adjusted. These variables would only be adjusted over time as more people use the system, in order to improve the Musiqo Quality Score's accuracy, and in response to the introduction of new (currently unforeseen) interaction methods.

Displaying the Musiqo Quality Score

In order to help people to choose quality content, the Musiqo Quality Score is displayed as supplementary information, in appropriate locations where people search, browse or view summary information for digital content. This could be item lists, or content which describes the item.

It is always presented as a percentage, e.g.
Musiqo Quality Score: 72%

Devices

The Musiqo Quality Score is not limited to a specific device (for example a personal computer). It could be applied to any electronic device which has the ability to pass the interaction data to a central location where the Musiqo Quality Score is calculated.

For example it could apply to smart phones, personal music players, internet connected home stereo systems, internet connected car stereo systems, televisions and home entertainment units and other digital devices which enable people to use and interact with digital content.

Applicable Content Types

The Musiqo Quality Score could be used to provide a quality measure of any type of digital content where people's interactions can be tracked and measured: For example, it could be used in (but not limited to) these domains:
i. Digitally stored music
ii. Electronic books or e-readers
iii. Digital streaming video
iv. Digital image libraries
v. Digital media content (such as recipes or news articles)

Employing the Musiqo Quality Score

In order to use the Musiqo Quality Score, the Digital Content Provider must identify and define suitable positive interactions to track and measure (see the example interactions in ‘How the Musiqo Quality Score works’ above). For each of these a weighting must also be defined.

For example, the interaction ‘Purchase’ could have a weighting of 25, whereas the interaction ‘Add to a playlist’ could have a weighting of 5. This would be based on the assumption that when somebody purchases an item (in this case, a song), it is a very important interaction which indicates that they like it, and therefore (to them) it is good quality. Adding a song to a playlist also indicates this, but to a lesser degree. The use of weightings helps to balance the interactions in the overall calculation.

### DEFINITIONS

Algorithm

The calculation used to derive the Musiqo Quality Score. Although this contains configurable variables, the structure of it defines the Musiqo Quality Score.

Configurable

Adjustable, or changeable, referring to the configurable items in the Algorithm, i.e. Interactions and Weightings.

Content

Also referred to as ‘item’. Digital media for consumption by Users of the Digital Content Provider, e.g. Music, E-books, Digital Video Content.

Digital Content Provider/Digital Content Provider's system.

The ‘Service’ which is employing the Musiqo Quality Score. For example an online digital music service, an online e-book store, or a digital video service. This is not limited to a centralised system, it could incorporate software installed on people's devices.

Interaction

Also ‘Positive action’, ‘Positive interaction’, ‘Scoring parameter’. An item selected by the Digital Content Provider for use in the Musiqo Quality Score algorithm.

Musiqo Quality Score

The automatic quality scoring system described in this document.

User, Users

A person or people who are users of a Digital Content Provider.

Weighting

A variable number which is applied to an Interaction in the Algorithm so that different Interactions can affect the Musiqo Quality Score by different amounts.

What is claimed is:

1. The unique algorithm and method for applying a quality score to digital content automatically, based on how people naturally use and interact with it within a software application or program as illustrated in ‘FIG. 1’ and described in the ‘Detailed description’.
